(19) United States
(12) Patent Application Publication
(10) Pub. No.: US 2023/0183065 A1
(43) Pub. Date: Jun. 15, 2023

(54) AQUEOUS SOLUTIONS OF CHLORINE DIOXIDE AND THE PROCESS TO PRODUCE THESE SOLUTIONS

(71) Applicant: ALETHIA LIFE SCIENCES AG, Widnau (CH)

(72) Inventor: Sebastian Oberwalder, London (GB)

(21) Appl. No.: 17/920,915

(22) PCT Filed: Apr. 27, 2021
(86) PCT No.: PCT/EP2021/060904

§ 371 Date: Oct. 24, 2022

(30) Foreign Application Priority Data
Apr. 27, 2020 (DE) 10 2020 111 417.6
May 18, 2020 (DE) 10 2020 113 390.1

(51) Int. Cl. C01B 11/02; C02F 1/50

(52) U.S. Cl. CPC C01B 11/028; C01B 11/024; C01B 11/026; C02F 1/50; C01B 2210/0003; C02F 2303/04

(57) ABSTRACT

This invention relates to aqueous solutions that contain chlorine dioxide, particularly ultrapure aqueous solutions of chlorine dioxide that can be used, for example, in the field of human and veterinary medicine to disinfect surfaces, devices and instruments, as well as a process for producing such aqueous solutions of chlorine dioxide. In particular, this invention is a process for producing an aqueous solution of chlorine dioxide in which a previously produced aqueous solution of chlorine dioxide is treated so that an ultrapure aqueous solution of chlorine dioxide is obtained. The invented process can be applied to all previously produced aqueous solutions of chlorine dioxide, regardless of the process used to produce these. The invented process can be used in particular to produce ultrapure aqueous solutions of chlorine dioxide much more easily and inexpensively from previously produced aqueous solutions of chlorine dioxide. Surprisingly, it was discovered that the aqueous solutions of chlorine dioxide produced using the invented process show a high level of purity and a surprisingly high level of stability.

### TECHNICAL FIELD

This invention relates to aqueous solutions that contain chlorine dioxide, particularly ultrapure aqueous solutions of chlorine dioxide that can be used, for example, in the field of human and veterinary medicine to disinfect surfaces, devices and instruments, as well as a process for producing such aqueous solutions of chlorine dioxide. In particular, this invention is a process for producing an aqueous solution of chlorine dioxide in which a previously produced aqueous solution of chlorine dioxide is treated so that an ultrapure aqueous solution of chlorine dioxide is obtained. The invented process can be applied to all previously produced aqueous solutions of chlorine dioxide, regardless of the process used to produce these. The invented process can be used in particular to produce ultrapure aqueous solutions of chlorine dioxide much more easily and inexpensively from previously produced aqueous solutions of chlorine dioxide. Surprisingly, it was discovered that the aqueous solutions of chlorine dioxide produced using the invented process show a high level of purity and a surprisingly high level of stability.

### BACKGROUND OF THE INVENTION

Chlorine dioxide and aqueous solutions of chlorine dioxide have long been known as very effective bleaches and disinfectants and are used on a large scale, for example, as a bleaching agent for cellulose (e.g. in paper production) and as a disinfectant to disinfect drinking water. Due to the known problems of producing and storing chlorine dioxide and aqueous solutions that contain chlorine dioxide (risk of explosion!), chlorine dioxide is usually produced directly before it is used from chlorate (ClO₃⁻) or chlorite (ClO₂⁻), or their salts, such as their alkali salts (e.g. sodium chlorate and sodium chlorite). During this process, chlorates, particularly sodium chlorate, are used as a cheaper starting material for the production of bleaching agents on a large scale, during which sulphur dioxide (Mathieson process) or hydrochloric acid or methanol (Solvay process), for example, are used to reduce the chlorate. For applications requiring a higher level of purity, such as disinfecting drinking water, chlorine dioxide is produced from more expensive chlorite, such as sodium chlorite, during which chlorine (chlorine-chlorite process), a suitable acid (acid-chlorite process), such as hydrochloric acid (hydrochloric acid-chlorite process), a suitable oxidising agent, such as peroxydisulfate (peroxydisulfate-chlorite process) or electric current (chlorite-electrolysis process) are used to oxidise the chlorite.

Due to its efficacy against dangerous pathogens, such as bacteria, viruses, protozoans, moulds and spores, aqueous solutions of chlorine dioxide are also used in the field of human and veterinary medicine as well as general hygiene, such as for disinfecting surfaces, devices, instruments etc. in medical practices, hospitals, laboratories, vehicles etc. Particularly for these kinds of applications in medicine, the aqueous solutions of chlorine dioxide used must be as free of impurities as possible and have a high level of storage stability to ensure it can be stockpiled and transported. Since it is distributed via wholesalers and retailers and stored temporarily or stockpiled by the end customer, storage stability of 18 to 24 months is a basic requirement. An economically viable product requires particularly long-term and stable storage in commercial packaging without any additional effort, such as requiring a continuous cold chain or similar. Furthermore, a high level of purity of solutions of chlorine dioxide is required particularly for use in medicine in order to avoid both unwanted reactions with surfaces to be treated (e.g. corrosion etc.) or with organic materials on the surface (e.g. formation of toxic chlorinated organic compounds), as well as the formation of any harmful residue.

During the production of chlorine dioxide and (aqueous) solutions that contain chlorine dioxide, the aim is generally to reduce potentially harmful impurities. In particular, toxic and environmentally unfriendly impurities should be completely avoided, where possible. For example, when used to disinfect drinking water, the permitted limit and, by extension, the permitted process of production is significantly influenced by the (expected) residual chlorates. The German Drinking Water Ordinance sets out in detail the processes permitted to disinfect drinking water and the substances that are to be used. The environmental impact of chlorine dioxide products depends significantly on the quantity of chlorine they contain as chlorine can react, for example, with organic compounds to form chlorinated organic compounds that are toxic or otherwise harmful to the environment. It is also known that certain impurities increase the corrosiveness of chlorine dioxide products or, in some cases, are even responsible for this, such as HCl residues that are present e.g. during production using hydrochloric acid. In addition, a particularly pure product is preferable because this means (at least visually) unwanted residue in or on a product treated with chlorine dioxide can be avoided. Most of these residues are generally not from the chlorine dioxide itself, but from impurities in its (aqueous) solution, such as salts or other compounds dissolved in it. After all, it is also known that impurities can have a negative impact on the stability of aqueous solutions of chlorine dioxide.

Earlier attempts to reduce toxic and environmentally harmful impurities or resulting reaction products have led to the development of processes for producing increasingly purer chlorine dioxide products (see e.g. the modification of the Mathieson and Solvay process “R2-R10 standard process”, e.g. described in H. Sixta: Handbook of Pulp. VCH-Wiley, Weinheim 2006, S. 734-777; and DE 195 14 612 A1; US 2010/0209528 A1; etc.). Various purification processes have also been developed (see e.g. GB 760,303 A; WO 2019/180049 A1 and the cited printed materials). Chronologically, these improvements relate to the fundamental production process in which fewer and fewer by-products occur. For example, the primary aim of the R2-R10 standard processes was to minimise harmful chlorine or chlorate residue. Later on, clean production processes were combined with known purification methods in order to further improve the overall quality.

For example, GB 760,303 A describes a process to produce aqueous solutions of chlorine dioxide in which gaseous chlorine dioxide manufactured in a reaction zone is enriched in a flow of inert gas, which is then conveyed into water in order to produce an aqueous solution of chlorine dioxide. The downside of this process is that unwanted gases that are used or occur in the production of gaseous chlorine dioxide, such as chlorine and/or sulphur dioxide, enter the produced solution of chlorine dioxide and are enriched. As a result, a chlorine dioxide solution produced using this process contains unwanted gases, particularly chlorine.

DE 195 14 612 A1 describes a process to produce fresh, chlorate-free aqueous solutions of chlorine dioxide for disinfecting drinking water by oxidising sodium chlorite with sodium peroxydisulfate as a chlorine-free oxidising agent in an aqueous solution at a pH between 5.5 and 9.5. While this process does not produce significant quantities of chlorate and other unwanted by-products, aqueous solutions of chlorine dioxide produced using this process contain large quantities of salts, such as sulfates and chlorides. These reduce the stability and increase the corrosiveness of the solutions and lead to unwanted residue.

US 2010/0209528 A1 describes a process to produce aqueous solutions of chlorine dioxide in which diluted chlorine gas is conveyed through a bed of mainly solid sodium chlorite and then conveyed into water in order to produce solutions of chlorine dioxide that contain less sodium chloride. According to US 2010/0209528 A1, sodium chloride has a negative effect on the stability of aqueous solutions of chlorine dioxide. However, the chlorites necessary for the process are relatively expensive and the produced chlorine dioxide solutions contain chlorine gas that not only accelerates the breakdown of chlorine dioxide but can also react with organic compounds to create toxic, chlorinated organic compounds. Furthermore, considerable safety precautions are required when using chlorine gas, which makes probably complex apparatus necessary in (large-scale) practice.

WO 2019/180049 A1 describes a process to produce aqueous solutions of chlorine dioxide in which chlorine dioxide is produced from chlorites using one of the processes known from drinking water disinfection and then conveyed into water via an inert gas in order to produce an aqueous solution of chlorine dioxide. By using suitable chlorine-free oxidising agents, such as peroxydisulfate, this process can be used to produce aqueous solutions of chlorine dioxide that contain less chlorine and salts. However, relatively expensive chlorite as the starting product as well as larger quantities of process chemicals and extremely complex apparatus are required for this.

General problems of these known processes for producing aqueous solutions of chlorine dioxide are the high costs of the starting materials (particularly chlorites) as well as the achievable purity and the associated storage stability of the produced products. Therefore, there was a need for a process to produce storable aqueous solutions of chlorine dioxide that can be used for applications in the medical field.

### DESCRIPTION OF THE INVENTION

The inventor of this invention found that storable aqueous solutions of chlorine dioxide can be produced inexpensively on a large scale if existing chlorine dioxide solutions, regardless of their original production process, are treated so that an ultrapure aqueous solution of chlorine dioxide is obtained. In particular, the inventor found that an aqueous solution of chlorine dioxide is particularly stable and therefore storable if particularly impurities in the form of salts and reactive gases are reduced as much as possible in the process so that the solution is of a high purity. Such impurities are suspected of accelerating the breakdown of the dissolved chlorine dioxide. Aqueous solutions of chlorine dioxide produced using this invention can be stored for 18 to 24 months without cooling.

This invention is therefore a key solution to the problem of producing high-purity solutions of chlorine dioxide as it provides a general process to purify (already existing) solutions of chlorine dioxide that yields an even better end product, regardless of the original production method. To do so, this invention first removes the unwanted gases, regardless of the starting product, by causing a reaction (e.g. reduction to ionic compounds) or prevents new ones forming as a result of the breakdown of the chlorine dioxide or other impurities and then desalinates the intermediate product. In addition to the improved quality and, as a result, the improved storage stability, this offers particularly significant economic benefits.

In particular, this invention is a process for producing an aqueous solution of chlorine dioxide. The invented process includes the following steps:
1) providing a first aqueous solution of chlorine dioxide,
2) adding a reagent to remove unwanted gases,
3) separating the chlorine dioxide from the first aqueous solution, and
4) dissolving the separated chlorine dioxide in water in order to obtained a purified second aqueous chlorine dioxide solution.

The invented process can be used to treat (purify) aqueous solutions of chlorine dioxide of any origin, regardless of the original process used to produce the aqueous solution of chlorine dioxide provided in step (1). As a result, not only chlorite-based processes (or indirect chlorite processes via electrolysis) can be used to produce the first aqueous solution of chlorine dioxide provided in step (1), but also the chlorate-based processes that are considerably less expensive. Therefore, the large-scale systems available in the paper industry can be used to produce the first aqueous solution of chlorine dioxide provided in step (1). This not only leads to cost savings of up to 90% but also means existing or standardised systems can be used to quickly build up very high capacities on a global scale or quickly scale production to demand. This quick scalability is crucial, particularly in case of unexpected events with a sudden increase in demand, for example the current Covid-19 pandemic.

In example versions of the invented process, the first chlorine dioxide solution can be produced by reacting a chlorate salt with sulphur dioxide (Mathieson process), reacting a chlorate salt with hydrochloric acid or methanol (Solvay process), reacting a chlorite salt with an acid (acid-chlorite process or acid-hypochlorite-chlorite process), for example hydrochloric acid (hydrochloric acid-chlorite process), reacting a chlorite salt with chlorine (chlorine-chlorite process), reacting a chlorite salt with sodium peroxydisulfate (peroxydisulfate-chlorite process) or electrochemical processes (e.g. chlorite-electrolysis process or chlorite-electrolysis process). The first chlorine dioxide solution is ideally produced from a chlorate salt, preferably sodium chlorate.

The first aqueous solution of chlorine dioxide can be provided in step (1) either at a certain volume or continuously. For example, the first chlorine dioxide solution provided in step (1) can be connected to primary apparatus for producing chlorine dioxide via a suitable siphon so that newly produced chlorine dioxide solution is available as a source for the invented process that can be run continuously.

In line with this invention, an aqueous solution of chlorine dioxide is a compound that is based on water as the solvent and contains chlorine dioxide in the dissolved form. Depending on the process used to produce the first aqueous solution of chlorine dioxide provided in step (1) of the invented process, this first chlorine dioxide solution contains both chlorine dioxide as well as unreacted starting materials, reaction products and/or breakdown products, such as dissolved chlorite ions, hypochlorite ions, chlorate ions, chloride ions, peroxydisulfate ions, chlorine gas, sulphur dioxide, etc.

Ideally, the first aqueous solution of chlorine dioxide provided in step (1) contains chlorine dioxide at a concentration of 2000 to 6500 ppm (unless otherwise stated, the ppm refers to the weight percentage), 4000 to 5500 ppm is preferred, and around 5000 ppm is particularly preferred.

In step (2) of the invented process, unwanted reactive gases are removed from the chlorine dioxide solution, particularly the reactive gases chlorine and/or sulphur dioxide, which were used or may occur during the production of the first chlorine dioxide solution provided in step (1). To do so, a suitable reaction partner (reagent) that is stable with chlorine dioxide is added to the first chlorine dioxide solution provided in step (1), which can be used to remove such reactive gases from the solution. In terms of this invention, the term “removal of unwanted gases” is used to refer to a chemical reaction that chemically binds the gas dissolved in the aqueous solution so that is can no longer be released from the solution as a gas. For example, a dissolved gas is chemically bound by reacting it with the reagent to create dissolved ionic bonds. For example, a gas can be oxidised or reduced or can be converted into a larger (ionic) molecule in an addition reaction. In any case, adding the reagent to remove unwanted gases and the following reaction with the dissolved gas prevents a gas from being released from the solution. The advantage of removing or chemically converting the unwanted gases by reacting them with the reagent in the aqueous solution compared to other processes based on e.g. reactions in the gas phase is that unwanted gases can be quickly and completely removed from the aqueous solution under controlled reaction conditions.

Suitable reagents to remove unwanted gases include hydrogen peroxide as well as carbonates, bicarbonates, chlorites and hydroxides, preferably in the form of their alkaline or alkaline earth salts, particularly sodium carbonate, sodium bicarbonate, sodium chlorite and sodium hydroxide. Sodium carbonate is particularly preferred in the invented process as a reagent to remove unwanted salts, preferably in the form of buffered sodium carbonate.

The reagent used in step (2) to remove unwanted gases is preferably added in a suitable (aqueous) solution, but can also be added as a solid (e.g. as a salt). As an aqueous solution, it is easier to dose, the reaction is faster and less or no additional mixing is required.

The reagent to remove unwanted gases should preferably be added in a sufficient quantity to remove all gases present in the first chlorine dioxide solution. For example, excess reagent is added, preferably at a molar ratio of reagent to chlorine of between 1.1:1 and 5:1, preferably between 1.5:1 and 2:1. If the chlorine content is unknown, the reagent is added at a molar ratio of reagent to chlorine dioxide of 0.1:1 to 2:1, preferably at a molar ratio of 0.5:1 to 1.5:1, depending on the production process. During this process, aqueous solutions of chlorine dioxide that have been produced with processes that are newer or known to be “cleaner” require a lower quantity of reagent than those produced using older or less “clean” processes.

In a preferred version of the invented process, the pH of the first solution provided in step (1) is set to a slightly acidic to neutral pH of 4.0 to 7.5, particularly preferably to a neutral pH, ideally between 6.5 and 7.5 before the reagent to remove unwanted gases is added in step (2). A neutral pH between 6.8 and 7.2 is even more preferred and a neutral pH of around 7.0 is particularly preferred. The neutral pH is preferably stabilised by adding a buffer system. Suitable buffer systems and processes to set a neutral pH are known in the field. Ideally, the buffer system is selected from a carbonate buffer system, a phosphate buffer system and a peroxydisulfate buffer system.

Setting a neutral pH of the aqueous solution of chlorine dioxide provided in step (1) effectively prevents new unwanted gases from forming, particularly chlorine gas, as a result of any acidic or alkaline reactions (such as the breakdown of chlorine dioxide).

Since sodium carbonate can be used as both a reagent to remove unwanted gases as well as to produce a carbonate buffer system, the pH of the first solution provided in step (1) can be set to a neutral pH by adding the reagent to remove unwanted gases in step (2) in a particularly preferred version of the invented process. This particular version of the invented process can be used especially if the first chlorine dioxide solution provided in step (1) is acidic (pH<6.5). Since all known production processes for chlorine dioxide take place in the acidic range, the solution present is generally acidic.

Step (3) of the invented process involves separating the chlorine dioxide from the chlorine dioxide solution purified of unwanted gases in step (2). In principle, the chlorine dioxide can be separated from the chlorine dioxide solution purified of unwanted gases in step (2) using any known process in the field. The preferred method is separating the chlorine dioxide from the aqueous solution in step (3) in the gas form, such as contact with a carrier gas (so-called “stripping” process) or by distillation under reduced pressure (so-called “sub-boiling” distillation).

Processes and equipment to separate chlorine dioxide using a carrier gas (stripping process) are known from e.g. GB 760,303 A and WO 2019/180049 A1. During these processes, a suitable carrier gas is usually brought into contact with an (aqueous) solution of chlorine dioxide so that chlorine dioxide in its gaseous state becomes enriched in the carrier gas. The chlorine dioxide-carrier gas mixture is then transported away from the first solution using appropriate lines, pumps etc. and then brought into contact with e.g. water in order to produce a second aqueous solution of chlorine dioxide.

Therefore, in a preferred version of the invented process, the chlorine dioxide solution purified of unwanted gases in step (2) is brought into contact with a suitable carrier gas. To do so, the carrier gas can be conveyed over the surface of the chlorine dioxide solution or blown through the chlorine dioxide solution using suitable nozzles in order to enrich the chlorine dioxide more quickly with the carrier gas. The carrier gas enriched with chlorine dioxide is then separated from the remaining aqueous solution using suitable lines, pumps etc.

The carrier gas used is preferably one that is inert to chlorine dioxide, such as air, nitrogen, carbon dioxide, oxygen, a noble gas such as argon and mixtures of these. Preferred carrier gases include nitrogen, carbon dioxide and argon. The preferred flow rate of the carrier gas is proportional to the quantity of chlorine dioxide solution. Ideally, the carrier gas is blown over the surface of the chlorine dioxide solution purified of unwanted gases in step (2) at a flow rate of 0.01 to 1% of the volume of chlorine dioxide solution per minute or blown through the chlorine dioxide solution purified of unwanted gases in step (2) at a flow rate of 0.1% to 10% of the volume of chlorine dioxide solution per minute. For example, the flow rate of air for a volume of 1000 litres of chlorine dioxide solution is 1 to 100 litres per minute, preferably 5 to 10 litres per minute.

An alternative version of the invented process involves separating the chlorine dioxide from the chlorine dioxide solution purified of unwanted gases in step (2) by distillation under reduced pressure (so-called “sub-boiling” distillation). The invented process allows for useful distillation by removing all unwanted gases from the chlorine dioxide solution in step (2) beforehand.

Presumably the low breakdown point (from 45° C.), the theoretical risk of explosion as well as the option of using other gases to displace chlorine dioxide from the aqueous solution (“stripping”) means that aqueous solutions of chlorine dioxide are not purified in current commercial methods by distillation.

The inventor of this invention found that distilling chlorine dioxide from an aqueous solution can be performed safely if the distillation temperature is reduced considerably below 45° C. by reducing the pressure. Under such reduced pressure conditions, chlorine dioxide can be separated from the chlorine dioxide solution purified from unwanted gases in step (2) by distilling it under reduced pressure without causing product breakdown or an explosion.

Ideally, the pressure is reduced so that the distillation can be performed at a temperature of 35° C. or less, preferably at room temperature (e.g. a temperature of 20 to 25° C.) or a temperature of 20° C. or 25° C. (standard room temperature). Any potential external influences such as energy input, hotspots, light etc. are eliminated as far as possible.

For laboratory use (=greatest purity of the final product at small production quantities), a combination of temperature and pressure is selected at which the water is definitely not boiling, for example more than 30 mbar at 20° C. or more than 40 mbar at 25° C.

For technical applications (=larger production quantities with a higher tolerance for impurities), a combination of temperature and pressure is selected to increase process safety, in which the water is boiling, for example 23 mbar at 20° C. or 32 mbar or 25° C. Ideally, the boiling point of the water is not quite reached to prevent a significant number of bubbles forming with even higher levels of impurities as a result, for example 24 mbar at 20° C. or 33 mbar at 25° C. The (almost) boiling state of the water takes into account certain impurities, while the mixture of water and chlorine dioxide ensures that the chlorine dioxide concentration is at no point over 10% and prevents even a theoretical risk of explosion at all times. Since in this version a considerably larger quantity of distillate is caught in the collecting vessel due to the distilled water, a greater difference in temperature of the starting vessel compared to the collecting vessel and/or cooling of the collecting vessel is desirable in this version.

In order to increase the purity, several distillation steps can be performed one after the other, the distillation can be performed over a cascade of several water vessels or the distillation can be performed one or several times.

Another preferred version of the invented process involves distillation under reduced pressure in combination with blowing a carrier gas through the chlorine dioxide solution purified from unwanted gases in step (2). This combination of “sub-boiling” distillation and the “stripping” process can separate chlorine dioxide particularly quickly from the chlorine dioxide solution purified from unwanted gases in step (2).

In all versions, additional (chemical) filters are ideal to increase the purity of the distillation flow between the vessels, such as preferably solid NaClO₂ as a chemical chlorine filter or particle filters resistant to chlorine dioxide as a salt filter, such as HEPA/ULPA filters made of PTFE.

The chlorine dioxide separated in step (3) is dissolved again in water in step (4) in order to create a purified second aqueous solution of chlorine dioxide. The water in which the chlorine dioxide separated in step (3) is dissolved is ideally pure water, for example distilled water or water than has been completely desalinated by osmosis (DI water).

Ideally, the pH of the water can be set to a neutral value (preferably a pH of 6.5 to 7.5, 6.8 to 7.2 is preferred, and approx. 7.0 is particularly preferred) with a suitable buffer system (preferably a carbonate, phosphate or peroxydisulfate buffer system). As such, the second aqueous solution of chlorine dioxide also contains the buffer system in addition to water and chlorine dioxide.

Particularly for use as a disinfectant, the second aqueous solution of chlorine dioxide can also contain one or several suitable surfactants that are stable with chlorine dioxide. Suitable surfactants or combinations of surfactants include, for example quaternary ammonium compounds and/or non-ionic surfactants, preferably carboxylic acid esters and/or phosphate esters, particularly ethoxylated aliphatic phosphate esters or phosphate-di-ester and/or ethoxylated carboxylic acid esters, preferably aliphatic carboxylic acid esters and/or alkyl ether phosphates, as well as fatty alcohol ethoxylates, fatty amine ethoxylates, alkylphenol ethoxylates, and/or fatty acid ethoxylates. Ideally, a chlorine dioxide solution produced with this invention contains a surfactant or a surfactant combination at a concentration of 10 wt % or less, a concentration of 5 wt % or less is preferred and a concentration of 10 wt % or less is particularly preferred.

In a preferred version, the surfactant is in the collected aqueous solution from the beginning as it encourages the absorption of the chlorine dioxide gas or minimises its re-stripping by the gas flow from the collecting vessel to the vacuum pump or gas outlet.

In a preferred version of the invented process, the water in which the chlorine dioxide separated in step (3) is dissolved is cooled to a temperature of less than 20° C., preferably to a temperature of less than 10° C.

If the chlorine dioxide is separated in step (3) using a carrier gas, the mixture of the carrier gas and chlorine dioxide is ideally conveyed into the (preferably cooled) water using suitable nozzles where it is distributed in order to dissolve the chlorine dioxide in the water more quickly. Equipment and processes suitable for this are known from e.g. GB 760,303 A and WO 2019/180049 A1.

If the chlorine dioxide in step (3) is separated by distillation under reduced pressure, the chlorine dioxide can be conveyed directly into the water (preferably cooled to e.g. 10° C. or lower) to condense and can be dissolved in it. The distillation process is a particularly preferred version of the invented process as, unlike the also possible carrier gas version, it offers the additional benefit that no flow of gas has to be conveyed through the water. There is always the risk with the flow of the produced product that the carrier gas that flows out will also remove chlorine dioxide from the product solution, which leads to a lower concentration of chlorine dioxide in the product and associated losses and costs.

An example preferred version of the invented process provides a first aqueous solution of chlorine dioxide that has been produced chlorate, for example by reacting sodium chlorate with hydrochloric acid. The pH of this first aqueous solution of chlorine dioxide is set to a neutral value between 6.5 and 7.5 and sodium carbonate is added in order to remove or chemically bind dissolved chlorine gas from the solution. Then the chlorine dioxide is distilled off under reduced pressure and dissolved in (pure) water in order to produce a purified second aqueous solution of chlorine dioxide.

In summary, this invention is a process to produce a high-purity aqueous solution of chlorine dioxide for which existing large-scale systems and processes can be used in order to produce large quantities of a cost-effective first aqueous solution of chlorine dioxide, which is then cleaned using the invented process so that it is suitable for use e.g. in the medical field. Particularly using cheaper starting substances, such as NaClO₄, HCl, NaCO₃, etc., can reduce costs by 75 to 90% compared to other processes. Furthermore, the invented process does not require the use of hazardous chemicals, such as chlorine gas or similar chemicals, which also makes the process easier to perform and reduces costs compared to other processes.

In particular, the advantage of removing the unwanted gases by reacting them in the aqueous solution compared to other processes based on e.g. reactions in the gas phase is that unwanted gases can be quickly and completely removed under controlled reaction conditions. The invented process therefore reliably produces chlorine-free chlorine dioxide solutions that are suitable, for example, for use in the medical field. Separating chlorine dioxide from the aqueous solution that has been cleaned beforehand of unwanted gases, particularly chlorine and sulphur dioxide, which is preferably performed by distillation under reduced pressure, and the subsequent dissolving in (pure) water reliably leads to an aqueous solution of chlorine dioxide that does not contain any unwanted salts. Unwanted gases include, for example, chlorates as the chlorine dioxide content is generally determined as a chlorate. It is also beneficial to keep the content of cations, such as sodium ions, as well as anions such as chloride ions, low.

Ideally, the entire content of impurities in the aqueous solution of chlorine dioxide produced using the invented process is less than 1000 ppm, less than 500 ppm is preferred, and less than 100 ppm is particularly preferred.

Depending on the intended use, an aqueous solution of chlorine dioxide produced using the invented process has a chlorine dioxide concentration of at least 100 ppm. Such a chlorine dioxide solution can then be used straight away without having to produce and dilute a concentrate beforehand. This invention also allows concentrates to be produced. Concentrates ideally have a chlorine dioxide concentration of at least 1500 ppm, at least 2000 ppm is preferred. The entire content of all impurities (gases and salts) is ideally less than 1000 ppm, less than 100 ppm is preferred. Ideally, the content of chlorine as well as the content of chlorate and sodium should be less than 100 ppm, and the total content of chlorine, chlorate and sodium together should preferably be less than 100 ppm.

Ideally, a chlorine dioxide solution produced using the invention process stored at room temperature (15 to 25 ° C.) for at least 18 months contains more than 90% of the original concentration of chlorine dioxide. In particular, a chlorine dioxide solution produced using the invented process stored at room temperature (15 to 25° C.) for at least 24 months contains more than 95% of the original concentration of chlorine dioxide.

The chlorine dioxide solutions produced with the invention are ideally packaged in suitable containers, for example in glass bottles with (poly)fluoroelastomers or PVC-coated caps or caps that are made of or contain (poly)fluoroelastomers, such as PTFE, PEEK, Viton® or a PTFE polymer mixture. As an alternative, plastic bottles made from these polymers can also be used. Ideally, the packaging offers protection from light as well as any other external influences, such as quick fluctuations in temperature, impacts etc. For example, the packaging can be an opaque container (e.g. a dark glass bottle or similar). In a preferred version, the chlorine dioxide solutions produced using the invented process are packed in shipping units of 4 or 6 glass bottles in a suitably sized Styropor box so that they are protected from light as well as impacts and quick fluctuations in temperature.

This invention is also a disinfectant based on the chlorine dioxide solution produced using the invented process. This is produced by adding the chlorine dioxide solution produced with the invention to at least one suitable chlorine dioxide-stable surfactant, such as a quaternary ammonium compound and/or a non-ionic surfactant, preferably carboxylic acid esters and/or phosphate esters, particularly ethoxylated aliphatic phosphate esters or phosphate-di-ester and/or ethoxylated carboxylic acid esters, preferably aliphatic carboxylic acid esters and/or alkyl ether phosphates, as well as fatty alcohol ethoxylates, fatty amine ethoxylates, alkylphenol ethoxylates, and/or fatty acid ethoxylates. Ideally, the chlorine dioxide solution produced using the invented process contains a surfactant or a surfactant combination at a concentration of 10 wt % or less, a concentration of 5 wt % or less is preferred and a concentration of 10 wt % or less is particularly preferred.

Ideally, the chlorine dioxide solutions produced using the invented process are used for surface disinfection as well as medical devices and in human and veterinary medicine. When used on surfaces, there should be hardly any or negligible residue. After all, it offers many benefits when used in medicine, be it as a medication or a medical device, as no impurities can influence the effect, which allows this to be much more clearly defined. These include lower quantities/concentrations being used and fewer side effects.

Ideally, the chlorine dioxide solution produced using the invented process is used in order to, for example, disinfect solid surfaces or water, particularly to remove bacteria, viruses, protozoans, moulds and/or spores from these surfaces or water. Use in human or veterinary medicine can also include the treatment of skin, nails, hooves, claws, wounds etc. Furthermore, a chlorine dioxide solution produced using the invented process can also be used to disinfect food.

The use of the pH-neutral chlorine dioxide solution produced using the invented process that contains one of the mentioned surfactants at a concentration of less than 500 ppm is particularly preferred, less than 150 ppm is even more preferred, as this solution has proven surprisingly well tolerated on the skin due to the low level of residue as well as the selected surfactant.

### EXAMPLES

The invented process is described below with example versions.

### Example 1

The pH of an aqueous solution of chlorine dioxide produced by reacting sodium chloride with hydrochloric acid using a large-scale production process for bleach (1.0 litre with a chlorine dioxide concentration of 5000 ppm and a pH of 2.0) is set to 7.0 by adding an aqueous solution of 5.0 wt % of sodium carbonate and 2.0 wt % of sodium hydrogen sulfate as a buffer in order to bind the chlorine gas dissolved in the solution. Then the chlorine dioxide is distilled off at room temperature (approx. 20° C.) and a pressure of 40 mbar and dissolved up to a concentration of 2000 ppm in 1.0 litre of distilled water (DI water) that is cooled to 10° C.

The aqueous solution of chlorine dioxide produced using this process is packed in glass bottles with a cap made of a PTFE polymer mixture and the bottles are stored in opaque, shock-absorbing Styropor packaging. After storage at room temperature for 18 months, the chlorine dioxide solution has a concentration of 1860 ppm (93% of the original concentration) and after 24 months a concentration of 1820 ppm (91% of the original concentration).

### Example 2

To make a disinfectant solution that contains chlorine dioxide, chlorine dioxide is distilled off, as in example 1, but then dissolved up to a concentration of 2000 ppm at 10° C. in 1.0 litre of distilled water that is set at a pH of 7.0 with a carbonate/phosphate buffer (sodium carbonate (soda) and phosphoric acid, approx. 0.01 mole each) and contains a surfactant (“Dehyton AB 30” from BASF) at a concentration of 2 g/l.

The aqueous disinfectant solution containing chlorine dioxide produced using this process is packed in glass bottles that are sealed with a cap made of a PTFE polymer, and the bottles are stored in opaque, shock-absorbing Styropor packaging.

After storage at room temperature for 18 months, the disinfectant solution has a chlorine dioxide concentration of 1900 ppm (95% of the original concentration) and after 24 months a concentration of 1860 ppm (93% of the original concentration).

1. A process for producing an aqueous solution of chlorine dioxide, involving the steps:
1) providing a first aqueous solution of chlorine dioxide,
2) adding a reagent to remove unwanted gases,
3) separating the chlorine dioxide from the first aqueous solution, and
4) dissolving the separated chlorine dioxide in water in order to obtained a purified second aqueous chlorine dioxide solution.

2. Process according to claim 1, whereby the reagent to remove unwanted gases is selected from hydrogen peroxide as well as carbonates, bicarbonates, chlorites and hydroxides, preferably in the form of their alkaline or alkaline earth salts; sodium carbonate, sodium bicarbonate, sodium chlorite and sodium hydroxide are preferred, and sodium carbonate is particularly preferred.

3. Process according to claim 1, whereby the pH of the first solution is set to a neutral value before adding the reagent to remove unwanted gases in step 2).

4. Process according to claim 1, whereby the pH of the first solution is set to a neutral value by adding the reagent to remove unwanted gases in step 2).

5. Process according to claim 2, whereby the neutral pH is a pH between 6.5 and 7.5.

6. Process according to claim 2, whereby the neutral pH is stabilised by adding a buffer system, preferably selected from a carbonate buffer system, a phosphate buffer system and a peroxydisulfate buffer system.

7. Process according to claim 1, whereby the chlorine dioxide is separated from the aqueous solution in step 3) by bringing it into contact with a carrier gas, preferably using an inert carrier gas, particularly nitrogen, carbon dioxide or argon.

8. Process according to claim 1, whereby the chlorine dioxide is separated from the aqueous solution in step 3) by distillation under reduced pressure, preferably at a temperature of 35° C. or less.

9. Process according to claim 1, whereby the water in which the chlorine dioxide in step 4) is dissolved is cooled, preferably to a temperature of less than 20° C.

10. Process according to claim 1, whereby the water in which the chlorine dioxide in step 4) is dissolved has a neutral pH between 6.5 and 7.5 and/or contains a surfactant.

11. Process according to claim 1, whereby the first chlorine dioxide solution is produced by reacting a chlorate salt with sulphur dioxide, reacting a chlorate salt with hydrochloric acid or methanol, reacting a chlorite salt with an acid, particularly hydrochloric acid, reacting a chlorite salt with chlorine, reacting a chlorite salt with sodium peroxydisulfate or electrochemical processes.

12. Process according to claim 1 that is performed continuously, particularly whereby the first aqueous solution of chlorine dioxide is continuously provided.

13. Aqueous solution of chlorine dioxide, obtained by the process according to claim 1.

14. Aqueous solution of chlorine dioxide according to claim 13, characterised by a total content of impurities of less than 1000 ppm and/or characterised by a chlorine dioxide concentration of at least 2000 ppm and/or characterised by a stability of more than 90% of the original concentration of chlorine dioxide over a period of at least 18 months at 15 to 25° C.

15. A method for using an aqueous solution of chlorine dioxide according to claim 13 for disinfection, preferably of solid surfaces or water, preferably to remove bacteria, viruses, protozoans, moulds and/or spores from these surfaces or water.

16. The method according to claim 15, characterised by a total content of impurities of less than 1000 ppm and/or characterised by a chlorine dioxide concentration of at least 2000 ppm and/or characterised by a stability of more than 90% of the original concentration of chlorine dioxide over a period of at least 18 months at 15 to 25° C.
